(19) United States
(12) Patent Application Publication
(10) Pub. No.: US 2010/0310924 A1
(43) Pub. Date: Dec. 9, 2010

(54) ELECTRODE GROUP FOR SECONDARY BATTERY AND SECONDARY BATTERY USING THE SAME

(76) Inventors: Mayumi Kaneda, Osaka (JP); Daisuke Suetsugu, Osaka (JP); Seiichi Kato, Osaka (JP)

Correspondence Address: MCDERMOTT WILL & EMERY LLP, 600 13TH STREET, NW, WASHINGTON, DC, 20005-3096, US

(21) Appl. No.: 12/918,029

(22) PCT Filed: Apr. 16, 2009
(86) PCT No.: PCT/JP2009/001761

§ 371 Date: Aug. 17, 2010

(30) Foreign Application Priority Data
May 22, 2008 (JP) 2008-133849
Jul. 29, 2008 (JP) 2008-194476
Sep. 1, 2008 (JP) 2008-223112

(51) Int. Cl. H01M 2/18; H01M 2/02

(52) U.S. Cl. 429/163; 429/246

(57) ABSTRACT

A positive electrode 14 has a positive electrode current collector 11 on which positive electrode mixture layers 12a, 12b are formed. A negative electrode 24 has a negative electrode current collector 21 on which negative electrode mixture layers 22a, 22b are formed.

The positive electrode 14 and the negative electrode 24 are wound into a flat shape with a separator 31 interposed therebetween, thereby an electrode group 4. In a curved portion located at an end portion in a major axis direction of the electrode group 4, at least one of the positive electrode 14 or the negative electrode 24 is provided with uncoated portions 13a, 13b; 23a, 23b in which the mixture layers 12a, 12b; 22a, 22b are not formed on the current collector 11;21.

### TECHNICAL FIELD

The present invention relates to electrode groups used for nonaqueous secondary batteries represented by lithium ion batteries, and to nonaqueous secondary batteries using the same.

### BACKGROUND ART

In recent years, lithium ion secondary batteries have been widely used as power supplies for mobile electronic devices. In such a lithium secondary battery, as active materials, for example, a carbon material capable of inserting and extracting lithium is used for a negative electrode, and a composite oxide containing transition metal and lithium, such as LiCoO₂, is used for a positive electrode, thereby providing a nonaqueous secondary battery having high potential and high discharge capacity. However, with the development of electronic devices and communication devices having an increased range of functions, a smaller size, and a reduced thickness in recent years, lithium ion secondary batteries having an increased capacity are required.

However, along with increase in capacity, rapid temperature rise may occur in a battery when an internal short circuit is occurred between a positive electrode and a negative electrode. For this reason, especially in large and high power secondary batteries, it is strongly required to improve the safety by, for example, limiting the rapid temperature rise.

In particular, in the case of a battery in which an electrode group wound into a flat shape is accommodated in a rectangular battery case, curved portions located on both sides in a longitudinal direction of the electrode group have a small radius of curvature. Therefore, at the time of forming the electrode group, large stress is applied to electrode plates in the curved portions having a small radius of curvature, so that a mixture layer may fall off, or at least one of the electrode plates may be fractured. Moreover, when the electrode plates expand/contract along with charge/discharge of the battery, at least one of the electrode plates may be buckled due to stress applied thereto, so that the electrode plate may be fractured. When the electrode plate is thus fractured, the fractured electrode plate may break through a separator, which may cause an internal short circuit between the positive electrode and the negative electrode. Moreover, in a cylindrical battery accommodating a cylindrical electrode group, such a problem may also arise in a portion having a small radius of curvature and located closer to the start end of the winding of an electrode group (the wind starting side).

As a method for reducing fracture of an electrode plate, Patent Document 1 describes a method in which a mixture layer 92 provided on the entirety of a surface of a current collector 91 is divided by a plurality of recessed portions 93 into mixture layer units 92U to configure an electrode plate 90 as shown in FIG. 16.

Moreover, Patent Document 2 describes a method in which a mixture layer provided on an inner circumference side of a current collector is made of a material having a higher flexibility than that of a mixture layer provided on an outer circumference side of the current collector.

### CITATION LIST

### Patent Document

Patent Document 1: Japanese Patent Publication No. 2002-343340

Patent Document 2: Japanese Patent Publication No. 2007-103263

### SUMMARY OF THE INVENTION

### Technical Problem

Patent Document 1 provides advantages in making the electrode plate flexible. However, when the method of Patent Document 1 is applied to form an electrode group wound into a flat shape, the recessed portions 93 are not located in curved a portion having a small radius of curvature on both sides in a longitudinal direction of the electrode group. Therefore, it is difficult to absorb bending stress applied to the portions having a small radius of curvature on both the inner circumference side and the outer circumference side.

Moreover, in Patent Document 2, stress caused by expansion/contraction of the electrode plates along with charge/discharge of the battery can be alleviated, and thus the advantages of reducing fracture of the electrode plates can be expected. However, in Patent Document 2, two types of mixture layers have to be formed on a current collector, which complicates processes for forming an electrode plate.

The present invention was devised in consideration of these conventional circumstances. It is an objective of the present invention to provide a highly reliable and safe secondary battery electrode group in which stress applied at the time of configuring the electrode group or stress caused due to expansion/contraction of electrode plates at the time of charge/discharge is alleviated to allow, for example, fracture of the electrode plate to be reduced.

### Solution to the Problem

A secondary battery electrode group according to the present invention includes: a positive electrode having a positive electrode current collector on which a positive electrode mixture layer is formed; a negative electrode having a negative electrode current collector on which a negative electrode mixture layer is formed; and a separator interposed between the positive electrode and the negative electrode which are wound, wherein the electrode group is formed into a flat shape, and at least one of the positive electrode or the negative electrode has an uncoated portion where the mixture layer is not formed on the current collector in a curved portion located at an end portion in a major axis direction of the electrode group.

In a preferable embodiment, the uncoated portion is formed at least one of both faces of the current collector, and the one face is located at an inner circumference side of the electrode group.

In a preferable embodiment, the uncoated portion is formed on both faces of the current collector, and the uncoated portion formed on the face located at an inner circumference side of the electrode group is larger in width than the uncoated portion formed on the face located at an outer circumference side of the electrode group.

In a preferable embodiment, the secondary battery electrode group further includes a porous insulating layer formed on a surface in the current collector.

In a preferable embodiment, a thin portion in which a thickness of the mixture layer is small is formed instead of the uncoated portion.

In a preferable embodiment, the uncoated portion is formed on both faces of the current collector, and the uncoated portion formed on one of the faces of the current collector is out of phase with the uncoated portion formed on the other face of the current collector.

In a preferable embodiment, the electrode group is formed into a cylindrical shape instead of the flat shape, and the uncoated portion is formed in a portion having a small radius of curvature located at a start end of the winding of the cylindrical electrode group instead of in the curved portion located at the end portion in the major axis direction of the flat electrode group.

In a preferable embodiment, the electrode group is made of layers of the positive electrode and the negative electrode stacked in a zig-zag manner with the separator interposed therebetween instead of a wound electrode group.

A secondary battery according to the present invention includes: an electrode group having a positive electrode, a negative electrode, and a separator, the electrode group being accommodated in a battery case together with an electrolyte, wherein the electrode group is any one of the secondary battery electrode groups described above.

### ADVANTAGES OF THE INVENTION

According to the present invention, stress applied at the time of configuring an electrode group, or stress caused due to expansion/contraction at the time of charge/discharge of electrode plates is alleviated to allow fracture or buckling of the electrode plates to be reduced, so that it is possible to provide a highly reliable and safe secondary battery electrode group.

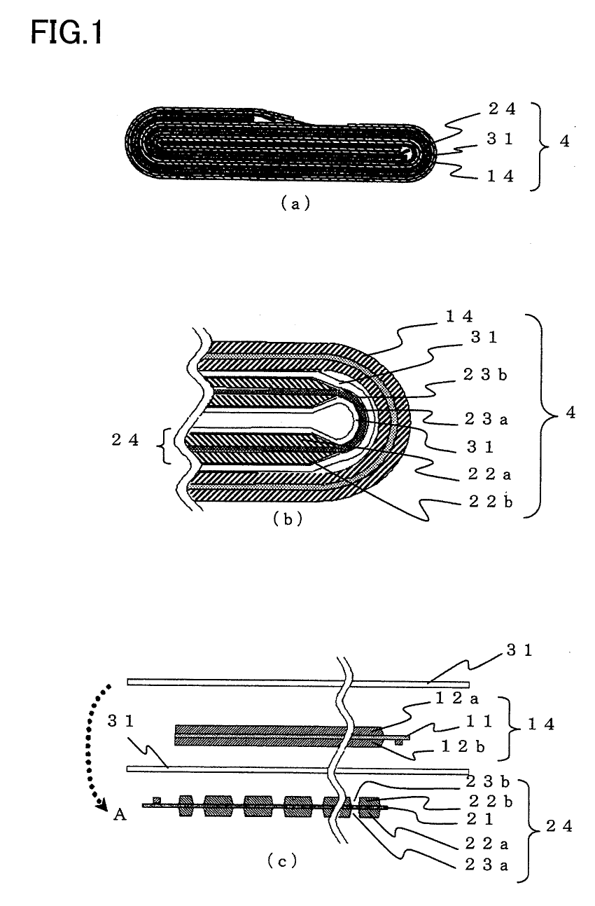

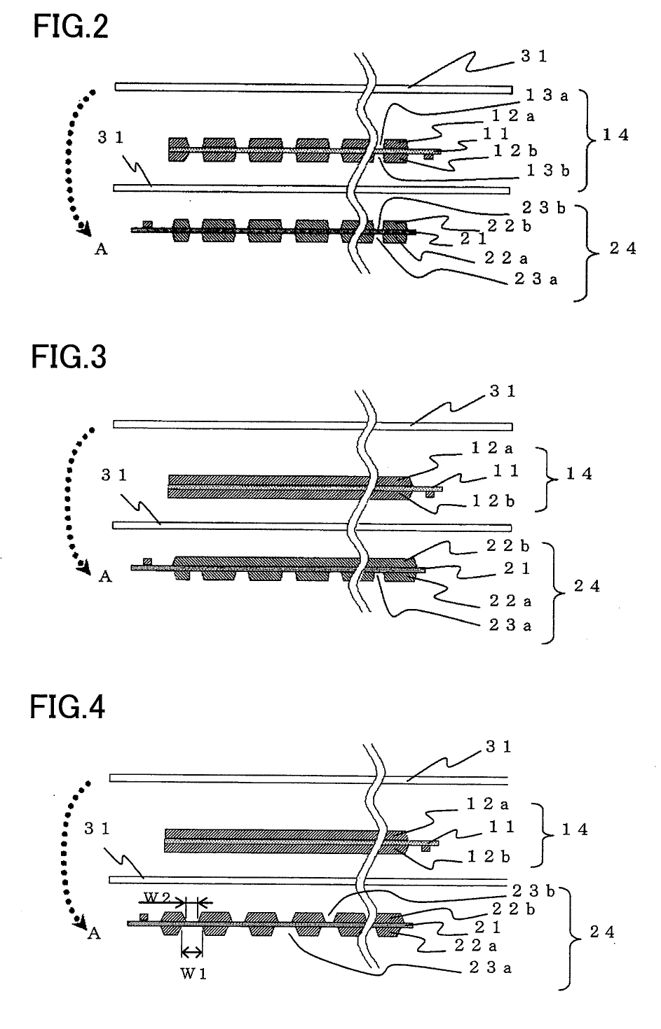

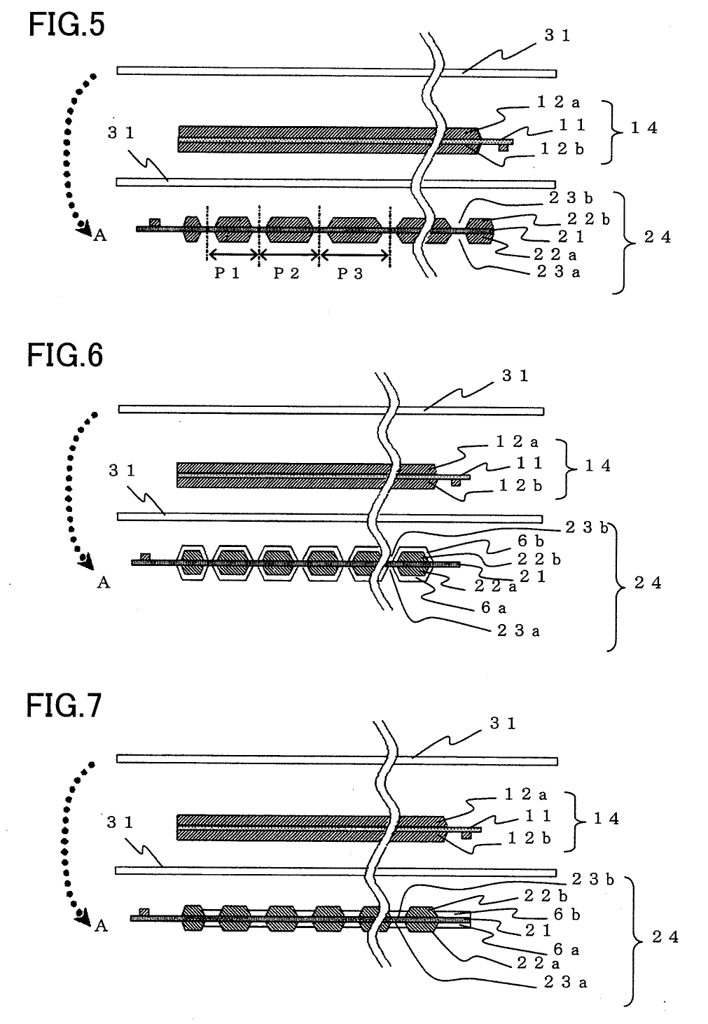

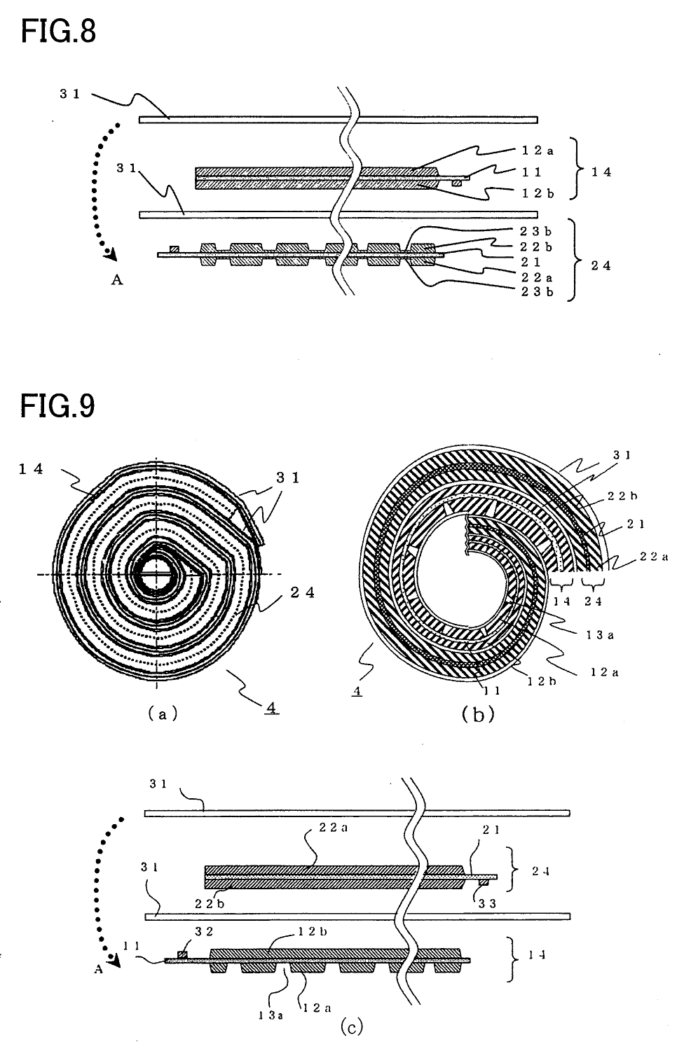

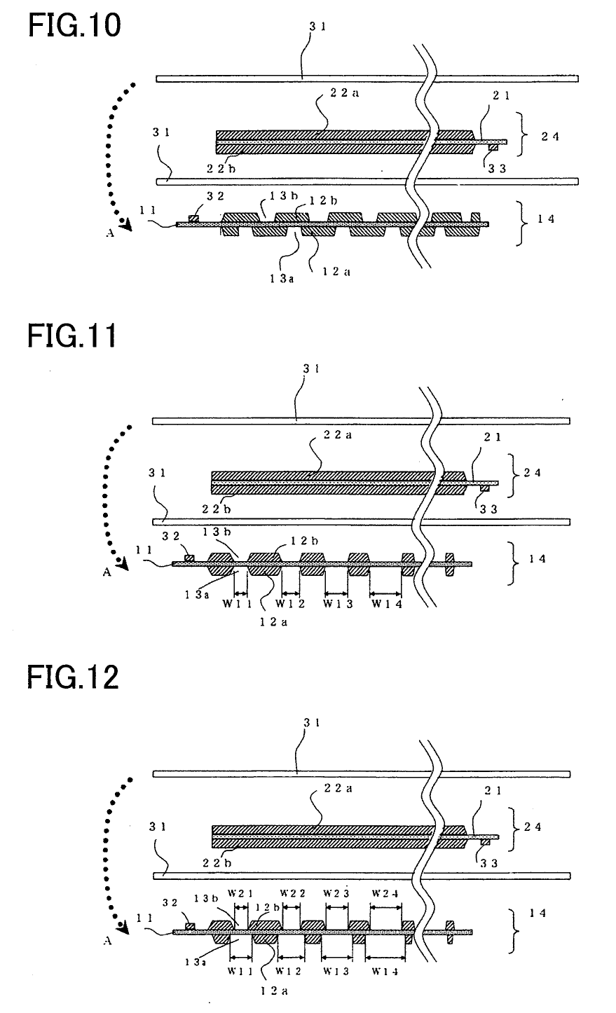

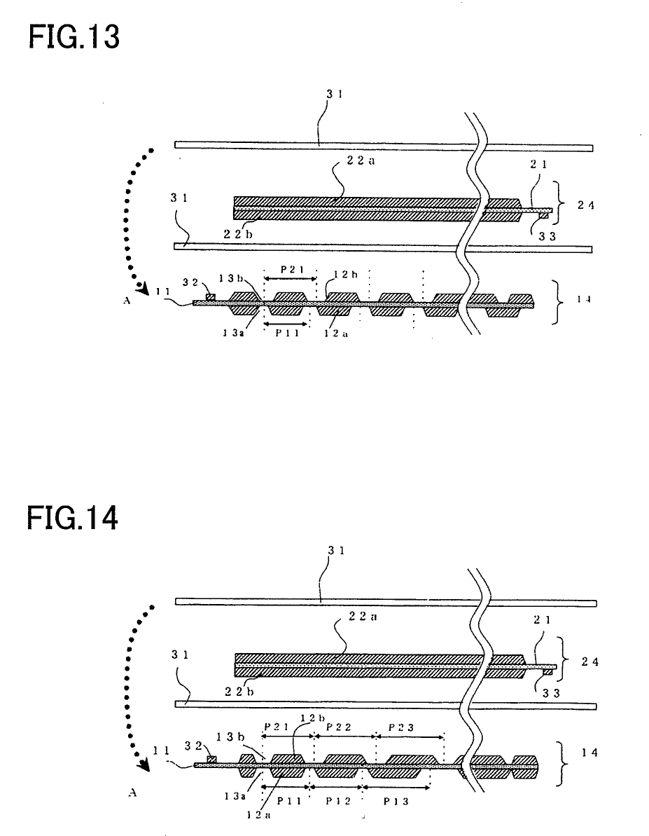

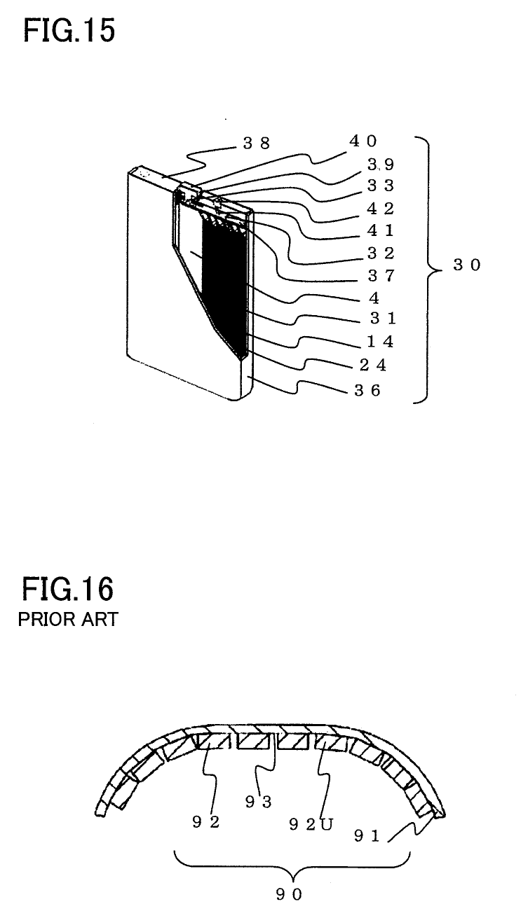

### BRIEF DESCRIPTION OF THE DRAWINGS

[FIG. 1] FIG. 1A is a cross-sectional view illustrating a configuration of an electrode group of a first embodiment of the present invention. FIG. 1B is a partially enlarged view of FIG. 1A. FIG. 1C is a cross-sectional view illustrating a configuration of a positive electrode, a negative electrode, and a separator before forming the electrode group.

[FIG. 2] FIG. 2 is a cross-sectional view illustrating a configuration of the positive electrode, the negative electrode, and the separator of the first embodiment of the present invention.

[FIG. 3] FIG. 3 is a cross-sectional view illustrating a configuration of the positive electrode, the negative electrode, and the separator of the first embodiment of the present invention.

[FIG. 4] FIG. 4 is a cross-sectional view illustrating a configuration of the positive electrode, the negative electrode, and the separator of the first embodiment of the present invention.

[FIG. 5] FIG. 5 is a cross-sectional view illustrating a configuration of the positive electrode, the negative electrode, and the separator of the first embodiment of the present invention.

[FIG. 6] FIG. 6 is a cross-sectional view illustrating a configuration of the positive electrode, the negative electrode, and the separator of the first embodiment of the present invention.

[FIG. 7] FIG. 7 is a cross-sectional view illustrating a configuration of the positive electrode, the negative electrode, and the separator of the first embodiment of the present invention.

[FIG. 8] FIG. 8 is a cross-sectional view illustrating a configuration of the positive electrode, the negative electrode, and the separator of the first embodiment of the present invention.

[FIG. 9] FIG. 9A is a cross-sectional view illustrating a configuration of an electrode group of a second embodiment of the present invention. FIG. 9B is a partially enlarged view of FIG. 9A. FIG. 9C is a cross-sectional view illustrating a configuration of a positive electrode, a negative electrode, and a separator before forming the electrode group.

[FIG. 10] FIG. 10 is a cross-sectional view illustrating a configuration of the positive electrode, the negative electrode, and the separator of the second embodiment of the present invention.

[FIG. 11] FIG. 11 is a cross-sectional view illustrating a configuration of the positive electrode, the negative electrode, and the separator of the second embodiment of the present invention.

[FIG. 12] FIG. 12 is a cross-sectional view illustrating a configuration of the positive electrode, the negative electrode, and the separator of the second embodiment of the present invention.

[FIG. 13] FIG. 13 is a cross-sectional view illustrating a configuration of the positive electrode, the negative electrode, and the separator of the second embodiment of the present invention.

[FIG. 14] FIG. 14 is a cross-sectional view illustrating a configuration of the positive electrode, the negative electrode, and the separator of the second embodiment of the present invention.

[FIG. 15] FIG. 15 is a view illustrating a configuration of a secondary battery including an electrode group of the embodiment of the present invention.

[FIG. 16] FIG. 16 is a cross-sectional view illustrating a configuration of a conventional electrode plate.

### DESCRIPTION OF EMBODIMENTS

Embodiments of the present invention will be described below with reference to the drawings. Note that the present invention is not limited to the embodiments below.

Moreover, modification can accordingly be made without departing from the spirit and scope of the present invention. Furthermore, combination with other embodiments may be possible.

### First Embodiment

FIG. 1A is a cross-sectional view schematically illustrating a configuration of a secondary battery electrode group of a first embodiment of the present invention. FIG. 1B is a partially enlarged cross-sectional view illustrating a curved portion and its neighborhood located at an end portion in a major axis direction of the electrode group formed into a flat shape. FIG. 1C is a cross-sectional view illustrating a configuration of a positive electrode, a negative electrode, and a separator before forming the electrode group.

As illustrated in FIGS. 1A-1C, a positive electrode 14 having a positive electrode current collector 11 on which positive electrode mixture layers 12a, 12b are formed and a negative electrode 24 having a negative electrode current collector 21 on which negative electrode mixture layers 22a, 22b are formed are wound with a separator 31 interposed therebetween to form an electrode group 4 having a flat shape. In the curved portion located at the end portion in the major axis direction of the electrode group 4, the negative electrode 24 includes uncoated portions 23a, 23b in which the negative electrode mixture layers 22a, 22b are not formed on the negative electrode current collector 21.

With this configuration, it is possible in the curved portion having a small radius of curvature to reduce fall-off of the mixture layer due to cracking or flaking of the mixture layer at the time of winding the electrode plates 14, 24, and to alleviate bending stress caused by the difference in thickness of the electrode plates between their inner and outer circumferences and applied to the electrode plates. Thus, fracture of the electrode plate can be prevented, reducing internal short circuits resulting from the fracture.

The uncoated portions 23a, 23b in the curved portion located at the end portion in the major axis direction of the electrode group 4 may be formed as described below. As illustrated in FIG. 1C, the portions 23a without the mixture layer in portions in a direction perpendicular to a longitudinal direction of the negative electrode mixture layer 22a are formed on a front face of the negative electrode current collector 21 of the negative electrode 24. The portions 23b without the mixture layer in portions of the negative electrode mixture layer 22b are also formed on a back face of the negative electrode current collector 21 of the negative electrode 24 such that the portions 23b have the same width and the same phase as those on the front face. The thus formed negative electrode 24 and the positive electrode 14 are wound in a spiral manner, with the separator 31 interposed therebetween, such that the uncoated portions 23a, 23b without the negative electrode mixture layers are located in the curved portion at the end portion in the major axis direction of the electrode group 4, and the negative electrode 24 and the positive electrode 14 are formed into a flat shape.

In order to form the uncoated portions 23a, 23b without the negative electrode mixture layers, it is possible to use the method of intermittent coating using, for example, a die coater. That is, a die is set to have a negative pressure in its manifold to stop discharge of a negative electrode mixture coating material from a tip portion of the die. Then, the pressure is released again to allow the discharge of the negative electrode mixture coating material. In this way, it is possible to form the uncoated portions 23a, 23b without the negative electrode mixture layers.

Note that the uncoated portions 23a, 23b without the negative electrode mixture layers may be formed in at least one or more portions in the longitudinal direction of the negative electrode current collector 21.

In the above embodiment, only the negative electrode 24 has the uncoated portions 23a, 23b. However, as illustrated in FIG. 2, the positive electrode 14 may also have uncoated portions 13a, 13b where the positive electrode mixture layers 12a, 12b are not formed. Alternatively, only the positive electrode 14 may have an uncoated portion.

The formation pattern of the uncoated portions 23a, 23b without the negative electrode mixture layers is not limited to that of FIG. 1C, but, for example, a variety of formation patterns as illustrated in FIGS. 3-5 can be used.

In FIG. 3, the uncoated portions 23a are formed only one face of the negative electrode current collector 21, and the negative electrode mixture layer 22b is formed on the entirety of the other face of the negative electrode current collector 21. Forming the uncoated portions 23a on the face at an inner circumference side of the electrode group 4 can alleviate compressive stress applied to the negative electrode mixture layer 22a at the inner circumference side. Thus, it is possible to more effectively reduce fall-off of the mixture layer, and fracture of the electrode plate which are caused by the compressive stress.

In FIG. 4, the width W1 of each uncoated portion 23a formed on the face at the inner circumference side of the electrode group 4 is larger than the width W2 of each uncoated portion 23b formed on a face at an outer circumference side of the electrode group 4. Tensile stress is applied to the negative electrode mixture layer 22b at the outer circumference side of the electrode group 4, and compressive stress is applied to the negative electrode mixture layer 22a at the inner circumference side of the electrode group 4. However, providing the uncoated portions 23a each having a larger width at the inner circumference side makes it possible to more effectively reduce fall-off of the mixture layer and fracture of the electrode plate which are caused by the compressive stress.

In FIG. 5, pitches P1, P2, P3, . . . of the uncoated portions 23a, 23b gradually increase in length from the start end to the finish end of the winding of the electrode group 4. Bending stress applied to the negative electrode 24 is larger at the start end than at the finish end of the winding of the negative electrode 24. However, adjusting the pitch length can ensure the formation of the uncoated portions 23a, 23b in the curved portion located at the end portion in the major axis direction of the electrode group 4. Thus, it is possible to more effectively reduce fall-off of the mixture layer and fracture of the electrode plate at the time of winding.

Here, a porous insulating layer may be formed on a face of a current collector on which an uncoated portion is formed. For example, as illustrated in FIG. 6, porous insulating layers 6a, 6b may be formed on the faces of the negative electrode current collector 21 such that the porous insulating layers 6a, 6b respectively cover the negative electrode mixture layers 22a, 22b in contrast to the formation pattern of the uncoated portions 23a, 23b illustrated in FIG. 1C. Protecting the negative electrode mixture layers 22a, 22b with the porous insulating layers 6a, 6b makes it possible to more effectively reduce fall-off of the mixture layer at the time of winding.

Alternatively, as illustrated in FIG. 7, the porous insulating layers 6a, 6b may be formed on faces of the uncoated portions 23a, 23b without the negative electrode mixture layers in contrast to the formation pattern of the uncoated portions 23a, 23b illustrated in FIG. 1C. Protecting the uncoated portions 23a, 23b with the porous insulating layers 6a, 6b makes it is possible to more effectively reduce internal short circuits even when the electrode plate fractures at the time of winding.

Note that the porous insulating layers 6a, 6b can be formed by applying, for example, a coating material including a material which contains an inorganic additive agent such as silica powder and Al2O3 powder, and a binder such as polyvinylidene fluoride (PVdF) to the negative electrode current collector 21 by, for example, die coating.

However, as illustrated in FIG. 1C, when the uncoated portions 23a, 23b where the negative electrode mixture layers 22a, 22b are not formed are provided on the negative electrode current collector 21, the total amount of the negative electrode mixture layers 22a, 22b is reduced.

Then, to further ensure the battery capacity, as illustrated in FIG. 8, thin portions where the negative electrode mixture layers 22a, 22b are small in thickness may be provided in portions where the uncoated portions 23a, 23b were supposed to be formed. Forming the thin portions of the negative electrode mixture layers 22a, 22b instead of the uncoated portions 23a, 23b makes it possible to reduce fall-off of the mixture layer and fracture of the electrode plate at the time of winding, and to alleviate the battery capacity reduction.

Here, in order to form the thin portions of the negative electrode mixture layers 22a, 22b, the pressure in the manifold of the die coater is lowered to reduce the discharge amount of the negative electrode mixture coating material, and then, the die coater is set to its original pressure again to allow the discharge of the negative electrode mixture coating material. In this way, it is possible to form the thin portions of the negative electrode mixture layers 22a, 22b.

Moreover, forming the thin portions of the negative electrode mixture layers 22a, 22b to have arched top portions in cross section makes it possible to more effectively reduce fall-off of the negative electrode mixture layers 22a, 22b.

### Second Embodiment

In the first embodiment, the uncoated portion where the mixture layer is not formed on the current collector is provided in the curved portion located at the end portion in the major axis direction of the flat electrode group to alleviate stress applied at the time of configuring the electrode group, or stress caused due to expansion/contraction of the electrode plates at the time of charge/discharge so that the advantage of reducing, for example, fracture of the electrode plate is obtained. Since a cylindrical electrode group also has a portion having a small radius of curvature at the start end of the winding of the electrode group, a similar advantage can be obtained by providing the relevant portion with an uncoated portion where a mixture layer is not formed.

FIG. 9A is a cross-sectional view schematically illustrating a configuration of a secondary battery electrode group of a second embodiment of the present invention. FIG. 9B is a partially enlarged cross-sectional view illustrating the portion having a small radius of curvature and its neighborhood at the start end of the winding of the electrode group formed into a cylindrical shape. FIG. 9C is a cross-sectional view illustrating a configuration of a positive electrode, a negative electrode, and a separator which are band-shaped before forming the electrode group. Note that the same reference symbols as those shown in the first embodiment are used to represent elements having the same functions as in the first embodiment.

As illustrated in FIGS. 9A-9C, a positive electrode 14 having a positive electrode current collector 11 on which positive electrode mixture layers 12a, 12b are formed and a negative electrode 24 having a negative electrode current collector 21 on which negative electrode mixture layers 22a, 22b are formed are wound with a separator 31 interposed therebetween to form an electrode group 4 having a cylindrical shape. In the portion having a small radius of curvature located at the start end of the winding of the electrode group 4, the positive electrode 14 includes uncoated portions 13a where the positive electrode mixture layer 12a is not formed on the positive electrode current collector 11.

With this configuration, it is possible in the portion having a small radius of curvature to reduce fall-off of the mixture layer at the time of winding the band-shaped electrode plates 14, 24, and to alleviate bending stress applied to the electrode plates. Thus, fracture of the electrode plate can be prevented, reducing internal short circuits resulting from the fracture.

Note that the uncoated portions 13a are provided only one face of the positive electrode current collector 11 in the embodiment above, but uncoated portions may be formed on both faces of the positive electrode current collector 11. Moreover, the uncoated portions 13a are provided only on the positive electrode 14, but the negative electrode 24 may also have an uncoated portion. Alternatively, only the negative electrode 24 may have an uncoated portion.

The formation pattern of the uncoated portions 13a, 13b without the positive electrode mixture layers is not limited to that of FIG. 9C, but, for example, a variety of formation patterns as illustrated in FIGS. 10-14 can be used.

In FIG. 10, the uncoated portions 13a, 13b without the positive electrode mixture layers 12a, 12b on a front face and a back face of the positive electrode are formed out of phase with each other. With this pattern, the effect of alleviating stress caused due to expansion/contraction of the positive electrode can be more effectively exerted in the longitudinal direction of the band-shaped electrode plate, so that it is possible to more effectively reduce fracture of the electrode plate.

In FIG. 11, the widths W11, W12, W13, . . . of the uncoated portions 13a, 13b without the positive electrode mixture layers 12a, 12b vary in the longitudinal direction of the positive electrode 14 in such a relationship that W11<W12<W13 . . . sequentially from the start end to the finish end of the winding of the electrode group. The uncoated portions 13a, 13b without the positive electrode mixture layers 12a, 12b increases in width from the start end to the finish end of the winding, so that it is possible to alleviate stress difference resulting from the difference in radius of curvature between the start end and the finish end of the winding of the positive electrode 14 when the electrode group 4 is configured. Thus, it is possible to reduce fracture or buckling of the positive electrode 14, and to effectively reduce internal short circuits resulting from the fracture or the buckling.

In FIG. 12, the uncoated portions 13a, 13b without the positive electrode mixture layers 12a, 12b are formed in the same phase and increase in width from the start end to the finish end of the winding of the electrode group (W11<W12<W13 . . . , W21<W22<W23 . . . ), and the widths of the uncoated portions 13a at an inner circumference side of the electrode group are larger than those of the uncoated portions 13b at an outer circumference side of the electrode group (W11>W21, W12>W22, W13>W23 . . . ). When the electrode group is formed by winding, tensile stress is applied to the positive electrode mixture layer 12a at the outer circumference side of the positive electrode 14, and compressive stress is applied to the positive electrode mixture layer 12b at the inner circumference side of the positive electrode 14 due to the difference in radius of curvature. However, providing the uncoated portions 13a having larger widths at the inner circumference side makes it possible to more effectively alleviate the stress difference resulting from the difference in radius of curvature between inner and outer sides of the winding.

In FIG. 13, pitches at which the uncoated portions 13a, 13b without the positive electrode mixture layers 12a, 12b are formed on the front face and the back face of the positive electrode are different from each other, wherein a pitch P21 at the outer circumference side of the electrode group is larger than a pitch P11 at the inner circumference side of the electrode group (the uncoated portions have the same width). When configuring the electrode group, tensile stress is applied to the positive electrode mixture layer 12a at the outer circumference side of the positive electrode 14, and compressive stress is applied to the positive electrode mixture layer 12b at the inner circumference side of the positive electrode 14. However, the pitch at the outer circumference side is larger than that at the inner circumference side, so that it is possible to effectively alleviate the stress difference resulting from the difference in radius of curvature between the inner and outer sides of the winding.

In FIG. 14, pitches P11, P12, P13, . . . , and P21, P22, P23, . . . at which the uncoated portions 13a, 13b without the positive electrode mixture layers 12a, 12b are formed increase in pitch length sequentially from the start end to the finish end of the winding of the electrode group (P11<P12<P13 . . . , P21<P22<P23 . . . ), and the pitches at the outer circumference side are respectively larger than those at the inner circumference side (P21>P11, P22>P12, P23>P13 . . . ). When the electrode group 4 is configured, bending stress applied to the positive electrode 14 is larger at the start end than at the finish end of the winding due to the difference in radius of curvature. However, the uncoated portions 13a, 13b increase in pitch from the start end to the finish end of the winding. Therefore, it is possible to effectively alleviate the stress difference resulting from the difference in radius of curvature between the start end and the finish end of the winding of the positive electrode 14.

Moreover, when the electrode group is formed by winding, tensile stress is applied to the positive electrode mixture layer 12a at the outer circumference side of the positive electrode 14, and compressive stress is applied to the positive electrode mixture layer 12b at the inner circumference side of the positive electrode 14 due to the difference in radius of curvature. However, when the uncoated portions 13a having large widths are provided at the inner circumference side, it is possible to alleviate the stress difference resulting from the difference in radius of curvature between the inner and outer sides of the winding.

FIG. 15 is a view illustrating a configuration of a secondary battery including an electrode group of the present embodiment. Here, an example of a rectangular secondary battery including an electrode group formed into a flat shape is illustrated, but a cylindrical secondary battery including a cylindrical electrode group is also the same in terms of the basic configuration as an electrode group.

As illustrated in FIG. 15, the positive electrode 14 whose active material is a composite lithium oxide and the negative electrode 24 whose active material is a material capable of retaining lithium are wound in a spiral manner with the separator 31 interposed therebetween to configure the flat electrode group 4. The electrode group 4 is accommodated in a bottomed, flat-shaped battery case 36 together with an insulating plate 37, and a negative electrode lead 33 led out from an upper portion of the electrode group 4 is connected to a terminal 40 to the periphery of which a gasket 39 is attached. Subsequently, a positive electrode lead 32 is connected to a sealing plate 38. Thereafter, a sealing plate 38 is inserted in an opening of the battery case 36, and is welded to the battery case 36 along an outer circumference of the opening of the battery case 36 to seal the opening. After that, a predetermined amount of an electrolyte including a nonaqueous solvent is poured in the battery case 36 through a hole 41. Then, a sealant 42 is welded to the sealing plate 38, thereby obtaining a rectangular secondary battery 30.

The present invention has been described referring to the preferable embodiments. However, the description in the embodiments does not limit the present invention, and as a matter of course, various modifications are possible. For example, an electrode group formed by winding a positive electrode and a negative electrode with a separator interposed therebetween has been described in the above embodiments, but an electrode group made of layers of a positive electrode and a negative electrode stacked in a bending manner with a separator interposed therebetween may be possible.

### EXAMPLES

The present invention will be described in detail below with reference to examples.

### First Example

(a) Formation of Positive Electrode

A positive electrode mixture coating material was prepared by mixing 100 parts by weight of lithium cobaltate as an active material, 2 parts by weight of acetylene black as a conductive material with respect to 100 parts by weight of the active material, and 2 parts by weight of polyvinylidene fluoride as a binding material with respect to 100 parts by weight of the active material together with a proper amount of N-methyl-2-pyrrolidone.

Next, as illustrated in FIG. 2, the positive electrode mixture coating material was applied to both faces of a positive electrode current collector 11 made of an aluminum foil having a thickness of 15 μm while uncoated portions 13a, 13b without positive electrode mixture layers were provided such that the uncoated portions 13a, 13b each had a width of 5 mm in a longitudinal direction and were formed in the same phase and at an equivalent pitch, thereby forming a positive electrode 14 having faces respectively provided with positive electrode mixture layers 12a, 12b each of which had a thickness of 100 μm after drying.

Further, the positive electrode 14 was pressed to have a total thickness of 165 μm so that the positive electrode mixture layers 12a, 12b each have a thickness of 75 μm. After that, slit processing was performed so that the positive electrode 14 had a width set for a rectangular secondary battery.

(b) Formation of Negative Electrode

A negative electrode mixture coating material was prepared by stirring 100 parts by weight of artificial graphite as an active material, 2.5 parts by weight (1 parts by weight in terms of solid content of a binding material) of styrene-butadiene copolymer rubber particle dispersion (solid content 40% by weight) as a binding material with respect to 100 parts by weight of the active material, and 1 part by weight of carboxymethylcellulose as a thickening agent with respect to 100 parts by weight of the active material together with a proper amount of water.

Next, as illustrated in FIG. 2, the negative electrode mixture coating material was applied to both faces of a negative electrode current collector 21 made of a copper foil having a thickness of 10 μm while uncoated portions 23a, 23b without negative electrode mixture layers were provided such that the uncoated portions 23a, 23b each had a width of 5 mm in the longitudinal direction and were formed in the same phase and at the equivalent pitch, thereby forming a negative electrode 24 having faces respectively provided with negative electrode mixture layers 22a, 22b each of which had a thickness of 110 μm after drying.

Further, the negative electrode 24 was pressed to have a total thickness of 180 μm so that the negative electrode mixture layers 22a, 22b each have a thickness of 85 μm. After that, slit processing was performed so that the negative electrode 24 had a width set for the rectangular secondary battery. (c) Fabrication of Secondary Battery

Using the positive electrode 14 and the negative electrode 24 which were formed in the way described above, a rectangular secondary battery 30 as illustrated in FIG. 15 was fabricated.

Specifically, the positive electrode 14 and the negative electrode 24 were wound, with a separator 31 made of a polyethylene microporous film having a thickness of 20 μm interposed therebetween, in a spiral manner in the A direction of FIG. 2 such that the portions 23a, 23b of a negative electrode where the mixture layers were not provided and the portions 13a, 13b of a positive electrode where the mixture layers were not provided were located in a position having a small radius of curvature, thereby forming an electrode group 4 having a flat shape. Hundred such electrode groups 4 were formed.

Next, 60 of the formed electrode groups 4 were extracted, and were each accommodated in a bottomed, flat battery case 36 together with an insulating plate 37. Then, a negative electrode lead 33 led out from an upper portion of the electrode group 4 was connected to a terminal 40 to the periphery of which an insulating gasket 39 was attached. Subsequently, a positive electrode lead 32 led out from the upper portion of the electrode groups 4 was connected to a sealing plate 38. After that, the sealing plate 38 was inserted in an opening of the battery case 36. The sealing plate 38 was welded along an outer circumference of the opening of the battery case 36 to close the opening. Thereafter, an electrolyte was poured in the battery case 36 through a hole 41, and then, a sealant 42 was welded to the sealing plate 38. In this way, rectangular secondary batteries 30 were formed.

### Second Example

In a manner similar to that described in the first example, a positive electrode 14 which was not provided with an uncoated portion without a positive electrode mixture layer was formed as illustrated in FIG. 3.

Moreover, in a manner similar to that described in the first example, a negative electrode 24 having a negative electrode current collector 21 only one surface of which was provided with uncoated portions 23a was formed as illustrated in FIG. 3. Note that the width of each uncoated portion 23a was 5 mm, which was the same as in the first example.

Using the positive electrode 14 and the negative electrode 24 which were formed as described above, a rectangular secondary battery 30 as illustrated in FIG. 15 was fabricated in a manner similar to that described in the first example.

### Third Example

In a manner similar to that described in the first example, a positive electrode 14 which was not provided with an uncoated portion without a positive electrode mixture layer was formed as illustrated in FIG. 4.

Moreover, in a manner similar to that described in the first example, a negative electrode 24 having a negative electrode current collector 21 both faces of which were provided with uncoated portions 23a, 23b was formed as illustrated in FIG. 4. Note that the width of each uncoated portion 23a was 5 mm, and the width of each uncoated portion 23b was 3 mm.

Using the positive electrode 14 and the negative electrode 24 which were formed as described above, a rectangular secondary battery 30 as illustrated in FIG. 15 was fabricated in a manner similar to that described in the first example.

### Fourth Example

In a manner similar to that described in the first example, a positive electrode 14 which was not provided with an uncoated portion without a positive electrode mixture layer was formed as illustrated in FIG. 5.

Moreover, in a manner similar to that described in the first example, a negative electrode 24 having a negative electrode current collector 21 both faces of which were provided with uncoated portions 23a, 23b was formed as illustrated in FIG. 5. Note that the width of each of the uncoated portions 23a, 23b was 5 mm, and pitches P1, P2, P3 of the uncoated portions 23a, 23b were respectively 20 mm, 30 mm, 40 mm from the start end to the finish end of the winding of the electrode group 4.

Using the positive electrode 14 and the negative electrode 24 which were formed as described above, a rectangular secondary battery 30 as illustrated in FIG. 15 was fabricated in a manner similar to that described in the first example.

### Fifth Example

In a manner similar to that described in the first example, a positive electrode 14 which was not provided with an uncoated portion without a positive electrode mixture layer was formed as illustrated in FIG. 6.

Moreover, in a manner similar to that described in the first example, a negative electrode 24 having a negative electrode current collector 21 both faces of which were provided with uncoated portions 23a, 23b was formed as illustrated in FIG. 6. Note that the width of each of the uncoated portions 23a, 23b was 5 mm. Furthermore, a coating material for porous insulating layers was applied to both the faces of the negative electrode current collector 21 so that the negative electrode mixture layers 22a, 22b were covered with the coating material, and the coating material was dried, thereby forming porous insulating layers 6a, 6b. The coating material for the porous insulating layers was prepared by mixing 100 parts by weight of silica powder having an average particle size of 1.0 μm, and 10 parts by weight of polyvinylidene fluoride with respect to 100 parts by weight of the silica powder together with a proper amount of N-methyl-2-pyrrolidone.

Using the positive electrode 14 and the negative electrode 24 which were formed in the manner above, a rectangular secondary battery 30 as illustrated in FIG. 15 was fabricated in a manner similar to that described in the first example.

### Sixth Example

In a manner similar to that described in the first example, a positive electrode 14 which was not provided with an uncoated portion without positive electrode mixture layer was formed as illustrated in FIG. 7.

Moreover, in a manner similar to that described in the first example, a negative electrode 24 having a negative electrode current collector 21 both faces of which were provided with uncoated portions 23a, 23b was formed as illustrated in FIG. 7. Note that the width of each of the uncoated portions 23a, 23b was 5 mm. Moreover, porous insulating layers 6a, 6b made of the same material as that used in the fifth example were formed on faces of the uncoated portions 23a, 23b.

Using the positive electrode 14 and the negative electrode 24 which were formed as described above, a rectangular secondary battery 30 as illustrated in FIG. 15 was fabricated in a manner similar to that described in the first example.

### First Comparative Example

In a manner similar to that described in the first example, a positive electrode 14 and a negative electrode 24 which were not provided with uncoated portions were formed. Using the positive electrode 14 and the negative electrode 24, a rectangular secondary battery 30 as illustrated in FIG. 15 was fabricated in a manner similar to that described in the first example.

Table 1 shows configurations of the first to sixth examples and the first comparative example.

TABLE 1

| | Portion | Electrode Plate | Width of Portion without | Pitch Difference of | |
|---|---|---|---|---|---|
| | without | including Portion | Mixture Layer on | Portion without Mixture | Porous |
| | Mixture | without Mixture | Front and Back Faces | Layer between Start End | Insulating |
| | Layer | Layer | of Electrode Plate | and Finish End of Winding | Layer |
| Ex. 1 | Both Faces | Positive Electrode and | Same Width | Same Pitch | None |
| | | Negative Electrode | | | |
| Ex. 2 | One Face | Negative Electrode | Same Width | Same Pitch | None |
| Ex. 3 | Both Face | Negative Electrode | Inner Circumference Side > | Same Pitch | None |
| | | | Outer Circumference Side | | |
| Ex. 4 | Both Face | Negative Electrode | Same Width | Different Pitch | None |
| Ex. 5 | Both Face | Negative Electrode | Same Width | Same Pitch | Mixture Layer |
| Ex. 6 | Both Face | Negative Electrode | Same Width | Same Pitch | Portion without |
| | | | | | Mixture Layer |
| Compar. | None | None | — | — | None |
| Ex. 1 | | | | | |

Following evaluation was performed on the examples and the comparative example described above.

<Fracture of Electrode Plate or Fall-off of Mixture Layer after Winding>

Forty of the 100 electrode groups 4 formed in each of the examples and the comparative example described above were extracted. Each of the extracted electrode groups 4 was disassembled to observe whether or not the electrode plate fractured, and whether or not the mixture layer fell off.

<Evaluation of Cycle Characteristic>

Thirty of the 60 rectangular secondary batteries fabricated in each of the examples and the comparative example above were extracted. The capacity retention rate with respect to the initial capacity when 500 cycles of charge/discharge were performed was observed. After the 500 charge/discharge cycles, each electrode group was disassembled, and observed whether or not the electrode plate fractured, and whether or not the mixture layer fell off.

<Drop Test>

Thirty of the 60 rectangular secondary batteries fabricated in each of the examples and the comparative example were extracted, and were charged for 2 hours under conditions that the maximum voltage was 4.2 V, and the current was 2 A. After that, six faces of each rectangular secondary battery 30 were subjected to a drop test 10 times by dropping the battery from a height of 1.5 m onto a concrete surface. Then, generated heat temperatures of 10 batteries were measured under a room temperature of 25° C. to obtain an average value of the generated heat temperatures of the 10 batteries.

<Round Bar Crushing Test>

The rectangular secondary batteries mentioned above were charged for 2 hours under conditions that the maximum voltage was 4.2 V, and the current was 2 A. After that, using a round bar having a diameter of 10 mm, a crushing test was performed in a direction perpendicular to a length direction with the batteries being laid down. Then, generated heat temperatures of 10 batteries were measured under a room temperature of 25° C. to obtain an average value of the generated heat temperatures of the 10 batteries.

<Heat Test>

The rectangular secondary batteries mentioned above were charged for 2 hours under conditions that the maximum voltage was 4.2 V, and the current was 2 A. After that, the batteries were inserted in a thermostatic bath, and the temperature of the thermostatic bath was raised by 5° C./minutes from an ambient temperature to 150° C. Generated heat temperatures of the batteries at the time were measured to obtain an average value of the generated heat temperatures of 10 batteries.

Table 2 shows results of the evaluation above.

TABLE 2

| | Fracture or | | Fracture, | | Round Bar | |
|---|---|---|---|---|---|---|
| | Fall-off of | Capacity | Buckling of | Drop Test | Crushing Test | 150° C. Heat Test |
| | Mixture | Retention | Electrode Plate, | Generated Heat | Generated Heat | Generated Heat |
| | Layer after | Rate after | Lithium | Temperature | Temperature | Temperature |
| | Winding | 500 Cycles | Deposition | (° C.) | (° C.) | (° C.) |
| Ex. 1 | None | 88% | None | 25° C. | 25° C. | 150° C. |
| | | | | (No Heat | (No Heat | (No Heat |
| | | | | Generated) | Generated) | Generated) |
| Ex. 2 | None | 86% | None | 25° C. | 25° C. | 150° C. |
| | | | | (No Heat | (No Heat | (No Heat |
| | | | | Generated) | Generated) | Generated) |
| Ex. 3 | None | 87% | None | 25° C. | 25° C. | 150° C. |
| | | | | (No Heat | (No Heat | (No Heat |
| | | | | Generated) | Generated) | Generated) |
| Ex. 4 | None | 89% | None | 25° C. | 25° C. | 150° C. |
| | | | | (No Heat | (No Heat | (No Heat |
| | | | | Generated) | Generated) | Generated) |
| Ex. 5 | None | 90% | None | 25° C. | 25° C. | 150° C. |
| | | | | (No Heat | (No Heat | (No Heat |
| | | | | Generated) | Generated) | Generated) |
| Ex. 6 | None | 88% | None | 25° C. | 25° C. | 150° C. |
| | | | | (No Heat | (No Heat | (No Heat |
| | | | | Generated) | Generated) | Generated) |
| Compar. | 10% | 75% | 50% | 50° C. | 120° C. | 170° C. |
| Ex. 1 | | | | (Heat | (Heat | (Heat |
| | | | | Generated) | Generated) | Generated) |

As shown in Table 2, in all of the first to sixth examples, defects such as fracture of the electrode plate and fall-off of the mixture layer were not observed. Moreover, observation of the capacity retention rate after 500 charge/discharge cycles with respect to the initial capacity and of the electrode groups disassembled after the 500 charge/discharge cycles revealed that defects such as lithium deposition, fracture of the electrode plate, buckling of the electrode plate, and fall-off of the mixture layer were not observed. Furthermore, defects were not observed in the drop test, the round bar crushing test, and the 150° C. heat test. This may be because fall-off of the mixture layer and fracture of the electrode plate at the time of winding can be reduced, which can reduce internal short circuits caused by the fall-off of the mixture layer and the fracture of the electrode plate, so that it is possible to maintain preferable characteristics of each battery. Moreover, in each battery of the fifth and sixth examples in which the faces of the electrode plate were provided with the porous insulating layers 6a, 6b, even if physical shock given externally to the battery brings the positive electrode 14 into contact with the negative electrode 24 to generate heat, the heat does not further spread, so that the safety from internal short circuits is further improved.

In contrast, in the first comparative example, fall-off of the mixture layer and fracture of the electrode plate after winding were observed. Moreover, the capacity retention rate after 500 charge/discharge cycles was also low, and fracture or buckling of the electrode plate, lithium deposition, or fall-off of the mixture layer also occurred at a high frequency. Furthermore, the generated heat temperatures were high in all of the drop test, the round bar crushing test, and the 150° C. heat test. This may be due to internal short circuits resulting from fall-off of the mixture or fracture occurring in a position having a small radius of curvature because the mixture layer is provided in the relevant position.

### Seventh to Twelfth Examples, Second Comparative Example

In seventh to twelfth examples, positive electrodes 14 and negative electrodes 24 as illustrated in FIGS. 2-8 were formed in manners similar to those described in the first to sixth examples to fabricate rectangular secondary batteries 30 as illustrated in FIG. 15. Note that in the seventh to twelfth examples, thin portions of mixture layers were formed instead of the uncoated portions formed in the first to sixth examples. Note that the thickness of each thin portion was 9 μm. Note that the configuration of a second comparative example was the same as that of the first comparative example.

Table 3 shows configurations of the seventh to twelfth examples and the second comparative example.

TABLE 3

| | Thin Portion Of | | Width Of Thin Portion of | Pitch Difference of Thin | |
|---|---|---|---|---|---|
| | Mixture Layer | Electrode Plate Including | Mixture Layer Thinly Coated | Portion of Mixture Layer | |
| | Thinly Coated | Thin Portion of Mixture | With Mixture Coating Material | Thinly Coated with Mixture | |
| | with Mixture | Layer Thinly Coated with | on Front Face and Back Face | Coating Material at Start End | |
| | Coating Material | Mixture Coating Material | of Electrode Plate | and Finish End of Winding | Insulating Layer |
| Ex. 7 | Both Faces | Positive Electrode and | Same Width | Same Pitch | None |
| | | Negative Electrode | | | |
| Ex. 8 | One Face | Negative Electrode | Same Width | Same Pitch | None |
| Ex. 9 | Both Faces | Negative Electrode | Inner Circumference Side > | Same Pitch | None |
| | | | Outer Circumference Side | | |
| Ex. 10 | Both Faces | Negative Electrode | Same Width | Different Pitch | None |
| Ex. 11 | Both Faces | Negative Electrode | Same Width | Same Pitch | Mixture Layer |
| Ex. 12 | Both Faces | Negative Electrode | Same Width | Same Pitch | Thin Portion of |
| | | | | | Mixture Layer |
| Compar. | None | None | — | — | None |
| Ex. 2 | | | | | |

The same evaluation as that performed on the first to sixth examples and the first comparative example was performed on the examples and the comparative example above.

Table 4 shows results of the evaluation.

TABLE 4

| | Fracture, | After 500 Cycles | | | Round Bar | |
|---|---|---|---|---|---|---|
| | Fall-off of | | Fracture, Buckling | Drop Test | Crushing Test | 150° C. Heat Test |
| | Mixture | Capacity | of Electrode Plate, | Generated Heat | Generated Heat | Generated Heat |
| | after | Retention | Lithium Deposition, | Temperature | Temperature | Temperature |
| | Winding | Rate | Fall-off of Mixture | (° C.) | (° C.) | (° C.) |
| Ex. 7 | None | 89% | None | 25° C. | 25° C. | 150° C. |
| | | | | (No Heat | (No Heat | (No Heat |
| | | | | Generated) | Generated) | Generated) |
| Ex. 8 | None | 87% | None | 25° C. | 25° C. | 150° C. |
| | | | | (No Heat | (No Heat | (No Heat |
| | | | | Generated) | Generated) | Generated) |
| Ex. 9 | None | 88% | None | 25° C. | 25° C. | 150° C. |
| | | | | (No Heat | (No Heat | (No Heat |
| | | | | Generated) | Generated) | Generated) |
| Ex. 10 | None | 90% | None | 25° C. | 25° C. | 150° C. |
| | | | | (No Heat | (No Heat | (No Heat |
| | | | | Generated) | Generated) | Generated) |
| Ex. 11 | None | 91% | None | 25° C. | 25° C. | 150° C. |
| | | | | (No Heat | (No Heat | (No Heat |
| | | | | Generated) | Generated) | Generated) |
| Ex. 12 | None | 89% | None | 25° C. | 25° C. | 150° C. |
| | | | | (No Heat | (No Heat | (No Heat |
| | | | | Generated) | Generated) | Generated) |
| Compar. | Observed | 75% | Observed | 50° C. | 120° C. | 170° C. |
| Ex. 2 | | | | (Heat | (Heat | (Heat |
| | | | | Generated) | Generated) | Generated) |

As shown in Table 4, in all of the seventh to twelfth examples, defects such as fracture of the electrode plate and fall-off of the mixture layer were not observed. Moreover, observation of the capacity retention rate after 500 charge/discharge cycles with respect to the initial capacity, and of the electrode groups disassembled after the 500 cycles revealed that defects such as lithium deposition, fracture of the electrode plate, buckling of the electrode plate, and fall-off of the mixture layer were not observed. Furthermore, defects were not observed in the drop test, the round bar crushing test, and the 150° C. heat test. This may be because fall-off of the mixture layer and fracture of the electrode plate at the time of winding can be reduced, which can reduce internal short circuits caused by the fall-off of the mixture layer and the fracture of the electrode plate, so that it is possible to maintain preferable characteristics of each battery. Moreover, in each battery of the fifth and sixth examples in which the faces of the electrode plate are provided with the porous insulating layers 6a, 6b, even if physical shock given externally to the battery brings the positive electrode 14 into contact with the negative electrode 24 to generate heat, the heat does not further spread, so that the safety from internal short circuits is further improved.

In contrast, in the second comparative example, fall-off of the mixture layer and fracture of the electrode plate after winding were observed. Moreover, the capacity retention rate after 500 charge/discharge cycles was also low, and fracture or buckling of the electrode plate, lithium deposition, or fall-off of the mixture layer also occurred at a high frequency. Furthermore, the generated heat temperatures were high in all of the drop test, the round bar crushing test, and the 150° C. heat test. This may be due to internal short circuits resulting from fall-off of the mixture or fracture occurring in a position having a small radius of curvature because the mixture layer is provided in the relevant position.

### Thirteenth to Twenty-third Examples, Third Comparative Example

In thirteenth to twenty-second examples, positive electrodes 14 and negative electrodes 24 as illustrated in FIGS. 2, 10, 4, 11-13, 5, 14, 6, and 7 were formed in manners similar to those described in the first to sixth examples, and using the positive electrodes 14 and the negative electrodes 24, cylindrical electrode groups as illustrated in FIG. 9 were formed, and further, cylindrical secondary batteries were fabricated using the electrode groups. Note that regarding the formation of the uncoated portions, the positive electrodes 14 and the negative electrodes 24 were configured in reverse to those illustrated in FIGS. 2, 4, 5, 6, and 7. Moreover, in a twenty-third example, a cylindrical electrode group was fabricated by using a positive electrode 14 in which porous insulating layers were formed to cover a positive electrode mixture layers and were also formed on uncoated portions without the positive electrode mixture layers. Furthermore, in a third comparative example, a cylindrical electrode group was formed using a positive electrode 14 and a negative electrode 24 which were not provided with uncoated portions in a manner similar to that described in the first example.

Table 5 shows configurations of the thirteenth to twenty-third examples and the third comparative example.

TABLE 5

| | Portion without Mixture | | | | | | | |
|---|---|---|---|---|---|---|---|---|
| | Layer | | Portion without Mixture Layer | | | Portion without Mixture | | Porous |
| | Type of | | on front face and back face of | | | Layer on Start End and | | Insulating |
| | Electrode | Formation | Electrode Plate | | | Finish End of Winding | | Layer |
| | Plate | Face | Phase | Width | Pitch | Width | Pitch | Provided/None |
| Ex. 13 | Positive | Both Faces | Same | Same | Same | Same | Same | None |
| | Electrode and | | Phase | Width | Pitch | Width | Pitch | |
| | Negative | | | | | | | |
| | Electrode | | | | | | | |
| Ex. 14 | Positive | Both Faces | Out of | Same | Same | Same | Same | None |
| | Electrode | | Phase | Width | Pitch | Width | Pitch | |
| Ex. 15 | Positive | Both Faces | Same | Different | Same | Same | Same | None |
| | Electrode | | Phase | Width | Pitch | Width | Pitch | |
| Ex. 16 | Positive | Both Faces | Same | Same | Same | Different | Same | None |
| | Electrode | | Phase | Width | Pitch | Width | Pitch | |
| Ex. 17 | Positive | Both Faces | Same | Different | Same | Different | Same | None |
| | Electrode | | Phase | Width | Pitch | Width | Pitch | |
| Ex. 18 | Positive | Both Faces | Out of | Same | Different | Same | Same | None |
| | Electrode | | Phase | Width | Pitch | Width | Pitch | |
| Ex. 19 | Positive | Both Faces | Same | Same | Same | Same | Different | None |
| | Electrode | | Phase | Width | Pitch | Width | Pitch | |
| Ex. 20 | Positive | Both Faces | Out of | Same | Different | Same | Different | None |
| | Electrode | | Phase | Width | Pitch | Width | Pitch | |
| Ex. 21 | Positive | Both Faces | Same | Same | Same | Same | Same | Mixture |
| | Electrode | | Phase | Width | Pitch | Width | Pitch | Layer |
| Ex. 22 | Positive | Both Faces | Same | Same | Same | Same | Same | Provided on |
| | Electrode | | Phase | Width | Pitch | Width | Pitch | Portions |
| | | | | | | | | without |
| | | | | | | | | Mixture Layer |
| Ex. 23 | Positive | Both Faces | Same | Same | Same | Same | Same | Provided on the |
| | Electrode | | Phase | Width | Pitch | Width | Pitch | Entire Surface |
| Compar. | Positive | None | — | — | — | — | — | None |
| Ex. 3 | Electrode and | | | | | | | |
| | Negative | | | | | | | |
| | Electrode | | | | | | | |

The following nail penetration test was performed on the examples and the comparative example above in addition to the evaluation as that performed on the first to sixth examples and the first comparative example.

<Nail Penetration Test>

Each cylindrical secondary battery was charged at a maximum voltage of 4.25 V, and then put in a thermostatic bath having a temperature of 60° C. without disassembling, and kept there until the temperature of the battery reached 60° C. An iron nail (3 mm in diameter) used as a presser was allowed to penetrate through the electrode group. The pressurizing condition was 1 mm/second, and the maximum pressure was 30 kN.

Then, after the voltage of the battery was reduced to 4.0 V or lower due to a short circuit, the nail was further moved by 200 μm, and then the movement of the nail was stopped. A surface of the battery was measured using a thermocouple to evaluate the amount of temperature rise of the battery for 5 seconds after the occurrence of the short circuit. In this way, an average value of the amounts of the temperature rise for 10 batteries was obtained.

Table 6 shows results of the evaluation above.

TABLE 6

| | | | | | Round Bar | Nail | 150° C. |
|---|---|---|---|---|---|---|---|
| | Fracture, | | Fracture, Buckling of | | Crushing | Penetration | Heat |
| | Fall-off | Capacity | Electrode Plate, | Drop Test | Test | Test | Test |
| | of Mixture | Retention | Lithium Deposition, | Generated | Generated | Generated | Generated |
| | after | Rate after | Fall-off of Mixture, | Heat Temp. | Heat Temp. | Heat Temp. | Heat Temp. |
| | Winding | 500 Cycles | etc. after 500 Cycles | (° C.) | (° C.) | (° C.) | (° C.) |
| Ex. 13 | None | 88% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 14 | None | 86% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 15 | None | 87% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 16 | None | 89% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 17 | None | 88% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 18 | None | 86% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 19 | None | 89% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 20 | None | 89% | None | 25° C. | 25° C. | 35° C. | 150° C. |
| | | | | (No Heat | (No Heat | (Little Heat | (No Heat |
| | | | | Generated) | Generated) | Generated) | Generated) |
| Ex. 21 | None | 90% | None | 25° C. | 25° C. | 25° C. | 150° C. |
| | | | | (No Heat | (No Heat | (No Heat | (No Heat |
| | | | | Generated) | Generated) | Generated) | Generated) |
| Ex. 22 | None | 88% | None | 25° C. | 25° C. | 25° C. | 150° C. |
| | | | | (No Heat | (No Heat | (No Heat | (No Heat |
| | | | | Generated) | Generated) | Generated) | Generated) |
| Ex.23 | None | 89% | None | 25° C. | 25° C. | 25° C. | 150° C. |
| | | | | (No Heat | (No Heat | (No Heat | (No Heat |
| | | | | Generated) | Generated) | Generated) | Generated) |
| Compar. | 10% | 75% | 50% | 50° C. | 120° C. | 120° C. | 170° C. |
| Ex. 3 | | | | (Heat | (Heat | (Heat | (Heat |
| | | | | Generated) | Generated) | Generated) | Generated) |

As shown in Table 6, in all of the thirteenth to eighteenth examples, defects such as fracture of the electrode plate and fall-off of the electrode mixture layer were not observed in the positive electrode 14 and in the negative electrode 24. Moreover, observation of the capacity retention rate after 500 charge/discharge cycles with respect to the initial capacity, and of the electrode groups disassembled after the 500 charge/discharge cycles revealed that defects such as lithium deposition, fracture of the electrode plate, buckling of the electrode plate, and fall-off of the electrode mixture layer were not observed.

Furthermore, defects were not observed in the drop test, the round bar crushing test, and the 150° C. heat test. This may be because fall-off of the mixture layer and fracture of the electrode plate at the time of winding can be reduced, which can reduce internal short circuits caused by the fall-off of the mixture layer and the fracture of the electrode plate, so that it is possible to maintain preferable characteristics of each battery.

Further, in the thirteenth to twentieth examples, the porous insulating layers 6a, 6b were not provided on outer faces of the electrode plate, so that little heat was generated in the nail penetration test externally giving physical shock, but thermal runaway was not exhibited.

Meanwhile, in the twenty-first to twenty-third examples, the porous insulating layers 6a, 6b were provided on outer faces of the electrode plate. Therefore, even if physical shock is externally given to each battery, bringing the positive electrode 14 into contact with the negative electrode 24 to generate heat, the porous insulating layers 6a, 6b prevent the heat from further spreading. Thus, it was found that providing the porous insulating layers 6a, 6b further improved the safety from internal short circuits.

In contrast, in the third comparative example, the electrode group disassembled after 500 charge/discharge cycles was observed, as a result of which defects such as lithium deposition, fracture of the electrode plate, buckling of the electrode plate, and fall-off of the electrode mixture layer were observed. Moreover, from the fact that high generated-heat-temperatures were observed in all of the drop test, the round bar crushing test, the nail penetration test, and the 150° C. heat test, the defects may be caused by the occurrence of internal short circuits resulting from the fall-off of the mixture layer and the fracture of the electrode plate or the buckling at the time of winding.

### INDUSTRIAL APPLICABILITY

The present invention is useful to batteries such as mobile power supplies which is required to increase in capacity as the range of functions of electronic devices and communication devices is increased.

### DESCRIPTION OF REFERENCE CHARACTERS

4 Electrode Group
6a, 6b Porous Insulating Layer
11 Positive Electrode Current Collector
12a, 12b Positive Electrode Mixture Layer
13a, 13b Uncoated Portions of Positive Electrode Mixture Layer
14 Positive Electrode
21 Negative Electrode Current Collector
22a, 22b Negative Electrode Mixture Layer
23a, 23b Uncoated Portions of Negative Electrode Mixture Layer
24 Negative Electrode
30 Rectangular Secondary Battery
31 Separator
32 Positive Electrode Lead
33 Negative Electrode Lead
36 Battery Case
37 Insulating Plate
38 Sealing Plate
39 Gasket
40 Terminal
41 Hole
42 Sealant

1. An electrode group for a secondary battery comprising:
a positive electrode having a positive electrode current collector on which a positive electrode mixture layer is formed;
a negative electrode having a negative electrode current collector on which a negative electrode mixture layer is formed; and
a separator interposed between the positive electrode and the negative electrode which are wound, wherein
the electrode group is formed into a flat shape, and
at least one of the positive electrode or the negative electrode has an uncoated portion where the mixture layer is not formed on the current collector in a curved portion located at an end portion in a major axis direction of the electrode group.

2. The electrode group for a secondary battery of claim 1, wherein
the uncoated portion is formed at least one of both faces of the current collector, and
the one face is located at an inner circumference side of the electrode group.

3. The electrode group for a secondary battery of claim 1, wherein
the uncoated portion is formed on both faces of the current collector, and
the uncoated portion formed on the face located at an inner circumference side of the electrode group is larger in width than the uncoated portion formed on the face located at an outer circumference side of the electrode group.

4. The electrode group for a secondary battery of claim 1, wherein
a porous insulating layer is formed on a surface in the current collector.

5. The electrode group for a secondary battery of claim 1, wherein
a thin portion in which a thickness of the mixture layer is small is formed instead of the uncoated portion.

6. The electrode group for a secondary battery of claim 1, wherein
the uncoated portion is formed on both faces of the current collector, and
the uncoated portion formed on one of the faces of the current collector is out of phase with the uncoated portion formed on the other face of the current collector.

7. The electrode group for a secondary battery of claim 1, wherein
the electrode group is formed into a cylindrical shape instead of the flat shape, and
the uncoated portion is formed in a portion having a small radius of curvature located at a start end of the winding of the cylindrical electrode group instead of in the curved portion located at the end portion in the major axis direction of the flat electrode group.

8. The electrode group for a secondary battery of claim 1, wherein
the electrode group is made of layers of the positive electrode and the negative electrode stacked in a zig-zag manner with the separator interposed therebetween instead of a wound electrode group.

9. A secondary battery comprising:
an electrode group having a positive electrode, a negative electrode, and a separator, the electrode group being accommodated in a battery case together with an electrolyte, wherein
the electrode group is the electrode group for a secondary battery of any one of claims 1-8.
